(19) United States
(12) Patent Application Publication
(10) Pub. No.: US 2007/0074151 A1
(43) Pub. Date: Mar. 29, 2007

(54) Business process to predict quality of software using objective and subjective criteria

(76) Inventors: Theodore Froilan Rivera, Raleigh, NC (US); David Lloyd Schmidt, Cary, NC (US); Adam Tate, Raleigh, NC (US); Scott Allen Will, Wake Forest, NC (US)

Correspondence Address: DILLON & YUDELL LLP, 8911 N. CAPITAL OF TEXAS HWY., SUITE 2110, AUSTIN, TX, 78759, US

(21) Appl. No.: 11/237,411

(22) Filed: Sep. 28, 2005

(51) Int. Cl. G06F 9/44

(52) U.S. Cl. 717/104

(57) ABSTRACT

A method and system for providing predictive quality analysis during software creation/development. A system of computation is provided that utilizes a combination of objective measures and subjective inputs to determine a final quality of the software that is being developed. In addition to using objective measures, in a unique, consistent, and deliberate fashion, subjective measures are also utilized to increase/improve the validity of the predictive quality analysis. The subjective elements utilized are ones that provide good indicators of the likelihood of success and customer satisfaction from a software quality standpoint.

### BACKGROUND OF THE INVENTION

1. Technical Field

The present invention relates generally to computer software and in particular to computer software development. Still more particularly, the present invention relates to analyzing software quality during computer software design and development.

2. Description of the Related Art

Computer software developers are continually developing new software and/or updating existing software to meet customer demands. Oftentimes, software is developed for specific customers, with whom the software developer contracts to provide the software, and the client expects software to be delivered that is both fully functional and which meets/exhibits a determinable level of quality. When software developers develop (or update) a computer software program or application, however, there is rarely any predictive analysis performed by which the developer is able to ascertain whether the quality of that software meets the expectations of the customer.

Occasionally, during testing of newly developed software, the quality of the software does not meet the customer expected quality, and the software developers (i.e., executives of the software development company) may be forced to defer release of the software product until product quality improves. Alternatively, the software developer may agree to release the product in order to gain a particular business advantage (e.g., first to market), without assurances that the product will meet the required quality for the customers. This decision (or business practice) may ultimately result in substantial costs/expense to the developer should the software prove to be of sub-standard quality (from the customers' perspective).

For example, with conventional software implementation, the cost of fixing a defect found by customers within released software may range between $5,000 and $50,000 per defect, depending on complexity. Post-release expenses are incurred as the developer is forced to carry out re-design, re-engineering, re-coding, or re-testing of the software product. Additionally, the cost of providing customer support varies, and may cost the company between $250 and $2,500.00 each time a customer phones in for support or for a software fix. In addition, certain intangible costs (i.e., costs that are not immediately quantifiable) may be incurred by the company as well. When a delivered software product fails to meet the quality expectation of a customer, the company loses the goodwill associated with customer satisfaction, and it is customer satisfaction that leads to repeat business.

As a result, a comprehensive, consistent, repeatable, and reliable business process is essential for more fully understanding the quality of software that will be released and the likelihood of success when deployed in the customer environment.

Developers today rely on verification or quality assurance teams that track individual indicators with various levels of meaning towards understanding the quality of the software product during development. Several different tools are available to help with various aspects of software testing. However, no single reliable approach exists that is generally applicable to all software development processes, as conventional methods provide a large range of approaches, some of which are product-specific and not generally applicable.

The existing methodologies for predicting quality of software each utilize only objective measures for their predictive analysis (see, for example, the article entitled Is this Software Done?, found in the Software Testing and Quality Engineering Magazine, Volume 4, Issue 2, March/April 2002). Virtually all of these methodologies depend upon defects identified during testing to perform a risk assessment. Another example is the Raleigh prediction model, described in Steve Kan's, Metrics and Models in Software Engineering, ISBN 0-201-72915-6, chapter 7, which discusses software metrics.

Obtaining a better understanding of how clients will view the quality of a particular piece of software may be crucial in some software deployments. Consequently, being able to understand and consistently quantify “quality risks” before software is released to customers is of utmost importance to the software development process. Clearly, a method for better prediction of the quality of software during software development will be a welcome improvement.

### SUMMARY OF THE INVENTION

Disclosed is a method, system, and computer program product for providing predictive quality analysis during software creation/development. A measurement method is provided that utilizes a combination of objective measures and subjective inputs to determine a final quality of the software that is being developed. In addition to using objective measures in a unique, consistent, and deliberate fashion, subjective measures are also utilized to increase/improve the validity of the predictive quality analysis. The subjective elements utilized are ones that provide good indicators of the likelihood of success and customer satisfaction from a software quality standpoint.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is the block diagram representation of an exemplary computer system that may be utilized to execute a software development quality analysis (SDQA) utility that analyzes software quality, in accordance with one exemplary embodiment of the invention;

FIGS. 2A-2F depict a series of spreadsheets/charts within which user input is requested and recorded to complete the quality analysis for a software product using the SDQA utility in accordance with one embodiment of the invention; and

FIG. 3 is a flow chart of the process by which SDQA utility determines the quality of software by utilizing the spreadsheets of FIGS. 2A-2F, according to one embodiment of the invention.

### DETAILED DESCRIPTION OF AN ILLUSTRATIVE EMBODIMENT

The present invention provides a method, system, and computer program product for providing predictive quality analysis during software creation/development. A measurement instrument is provided that utilizes a combination of objective measures and subjective inputs to determine a final quality of the software that is being developed. In addition to using objective measures in a unique, consistent, and deliberate fashion, subjective measures are also utilized to increase/improve the validity of the predictive quality analysis. The subjective elements utilized are ones that provide good indicators of the likelihood of success and customer satisfaction from a software quality standpoint.

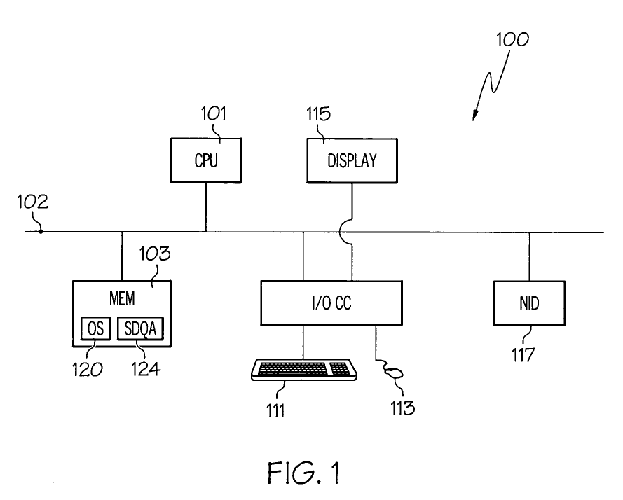

With reference now to the figures, and in particular FIG. 1, there is illustrated a computer system within which features of the invention may advantageously be implemented. Computer system 100 comprises processor 101 coupled to memory 103 and input/output (I/O) controller 105 via a system bus 102. I/O controller 105 provides the connectivity to input/output devices, such as keyboard 111 and mouse 113 and display device 115. Computer system also comprises a network interface device 117 utilized to connect computer system 100 to another computer system and/or computer network (not shown).

Located within memory 103 and executed on processor 101 are a number of software components, including operating system (O/S) 120 and software development quality analysis (SDQA) utility 124. SDQA utility 124 is the principal software component that enables the implementation of the quality analysis/assessment features provided by the present invention. While described in the context of a computer system, the described features of the invention may be completed without use of a computer system.

According to the illustrative embodiment, implementation of the invention involves a user executing the SDQA utility 124 and entering a series of inputs requested within the SDQA utility. It is noted that, while the illustrative embodiment of the invention is described with specific reference to a computer-executed process via the SDQA utility, the functionality associated with the invention is not necessarily limited to implementation with a computer or within a computing environment. The calculations of interest in determining the quality of developed software may be completed utilizing pen and paper, an abacus or other non-electronic counting tool, an electronic adding tool, such as a calculator, as well as a computer device, which may be hand-held (or portable) or a desktop computer device. For simplicity in describing the invention as well as providing a context for generating spreadsheets utilized to enter the subjective data and perform the calculations of the quality of software, a computer implemented method is described that includes use of the SDQA utility within a computer system. This specific implementation is, however, not meant to imply any limitations on the invention.

Several major areas (or phases of development) are identified and programmed within SDQA utility. Compiling information for each of these areas is required for SDQA to provide a comprehensive analysis of the quality of the software. The major areas identified apply to any software and as such the SDQA utility is generally applicable to analyze any developed software.

These major areas are listed below along with a brief description of their respective functionality:
(1) design—the design task is the first accomplished in any software development lifecycle. During software design, the designers utilize particular methodologies, etc. that are relevant to an analysis of the quantity of the finished software product
(2) development—the development task involves certain amounts of inspections, and testing at as the software is being developed;
(3) Component Verification Test (CVT)—this involves a number of testing processes;
(4) Information Development and Design (IDD)—involves personnel use and creation of manuals for use of the software;
(5) System Verification Test (SVT)—this involves a different set of testing processes related to service; and
(6) Process—the process undertaken by the various developers in determining whether CVT and SVT tests were sufficient.

The invention provides a method for utilizing objective and subjective criteria to predict the end customer's view of the quality of software. In the illustrative embodiment, the invention employs a consistent and sophisticated process to address software quality issues by having quality assurance teams review the development process and interact with the SDQA utility to produce a final, quantitative, quality analysis result.

The methodology presented by the described embodiment of the invention employs a consistent and sophisticated process to address the following software quality issues by having quality assurance teams answer questions concerning: (1) particular development methodologies utilized; (2) whether or not industry standard best practices were employed; (3) the type of customer interaction that occurred; (4) different areas of project “churn,” and others. Among the software quality issues analyzed by the quality assurance teams are the following: (1) How is consistency ensured?; (2) How does one validate that the software that is about to be shipped/released is of a high quality?; (3) Are the risks quantifiable?; (4) What assurances can be offered to clients that the release being shipped is trustworthy?; (5) Have the more intangible elements been taken into account, rather than only identifying the numbers of defects?

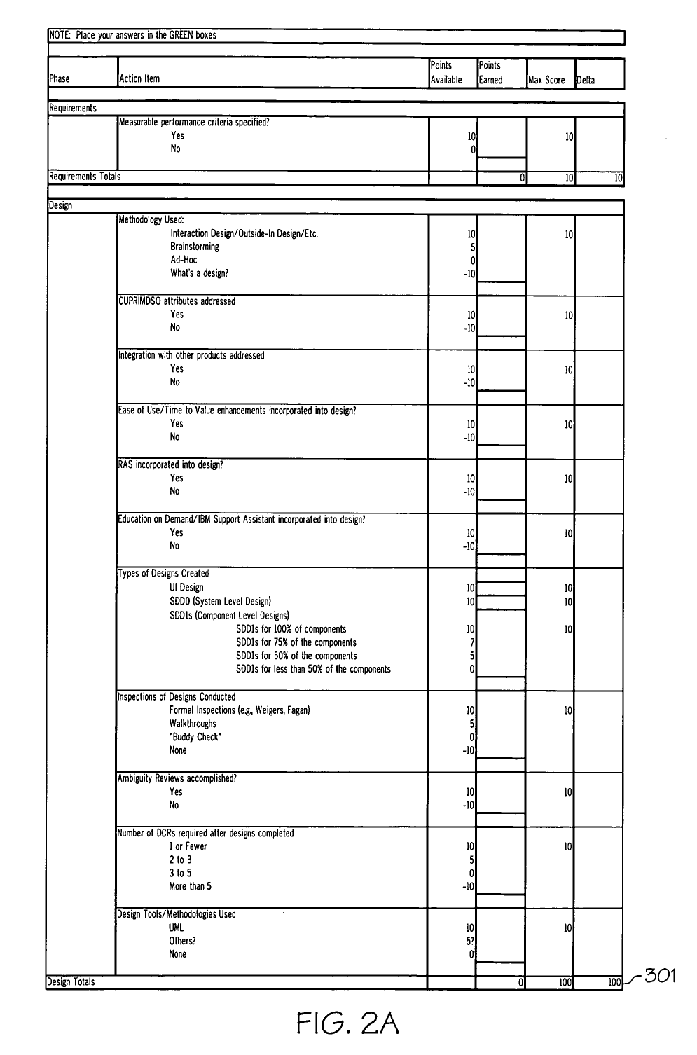

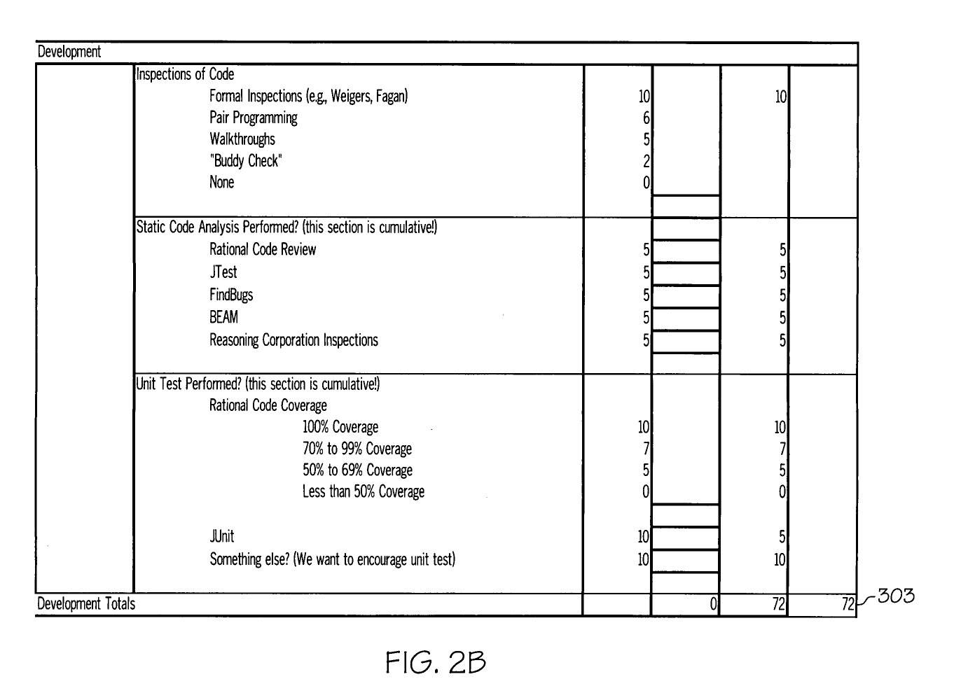

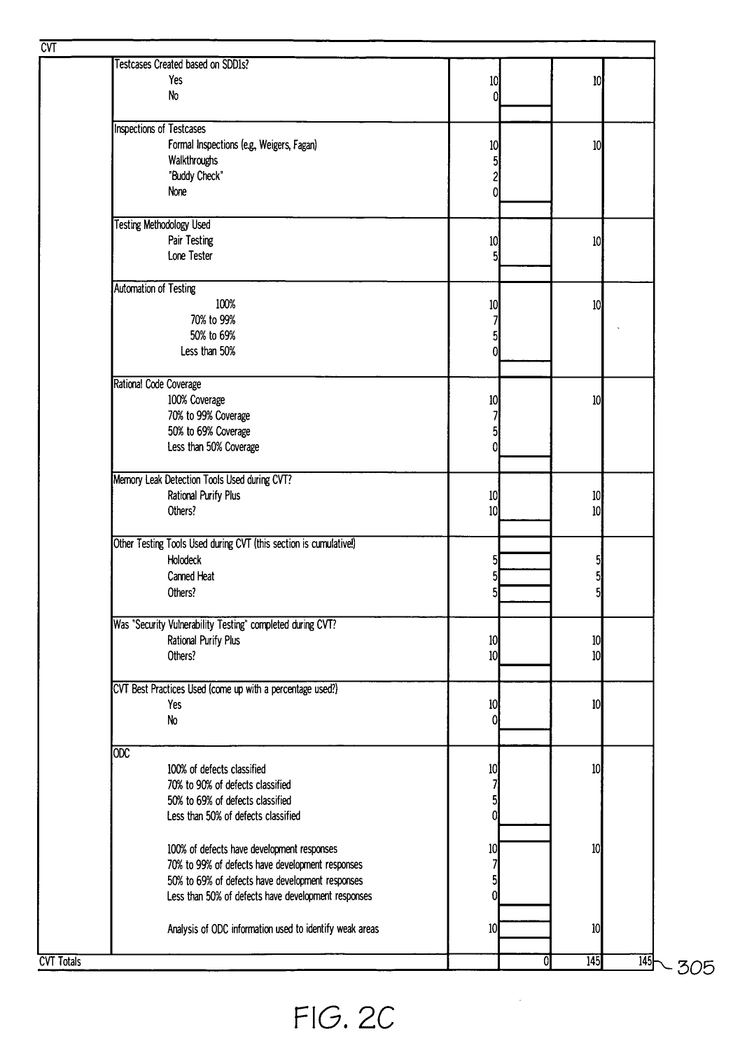

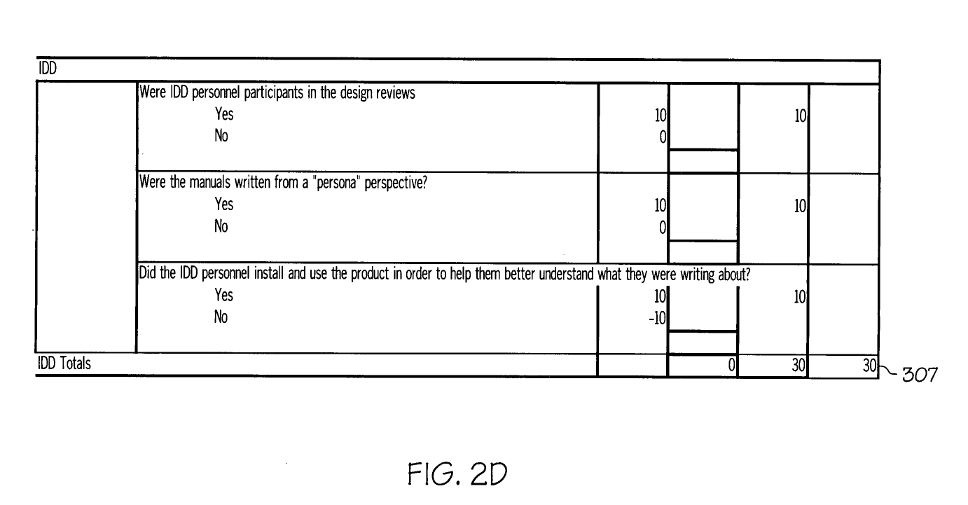

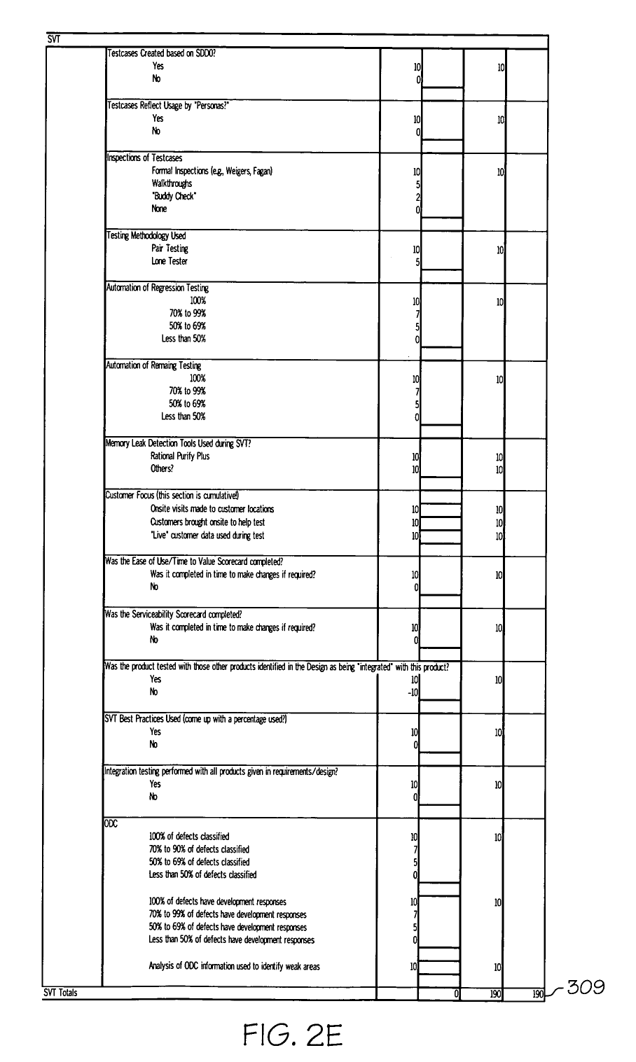

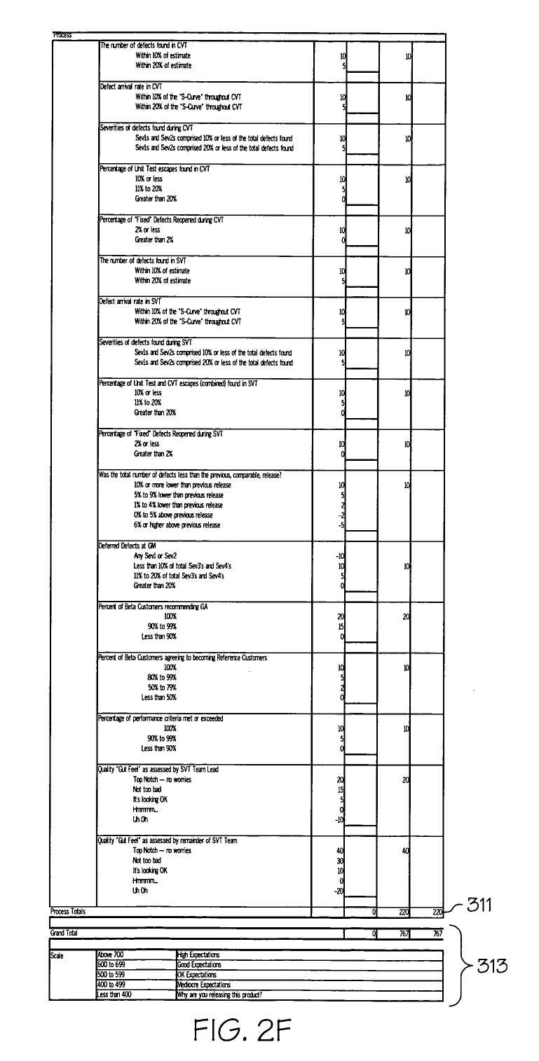

FIGS. 2A-2F illustrates the series of spreadsheets/charts provided to the developer for input of subjective criteria during quality analysis of a software product being developed. The spreadsheets are provided within a graphical user interface (GUI) of SDQA utility 124, which is executed by processor 101 when selected for execution by a user. While many different action items and associated point totals, etc., are illustrated in the figures, the specific items illustrated are provided solely for illustration and not meant to imply any limitations on the invention.

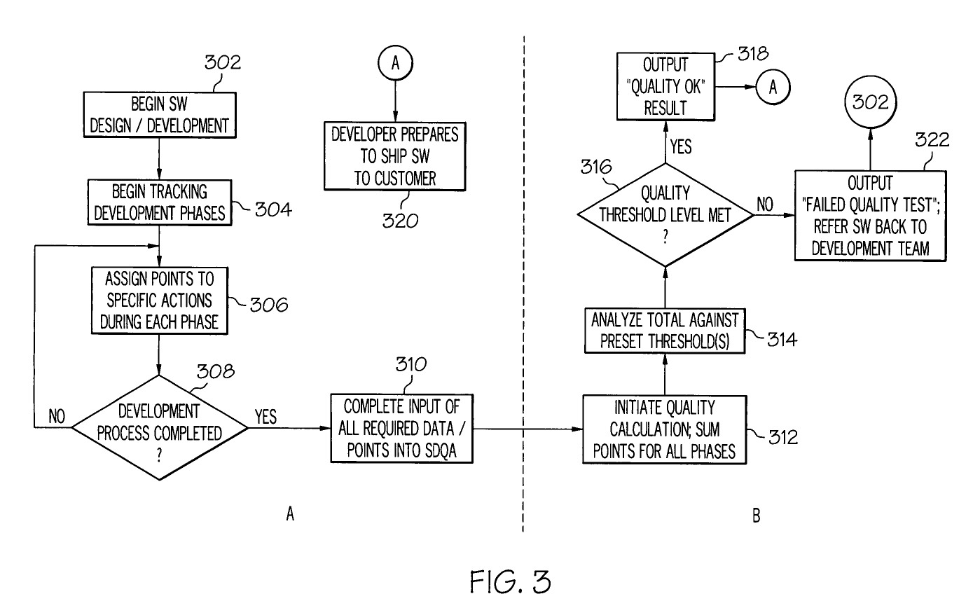

Each spreadsheet of FIGS. 2A-2F corresponds to one of the above listed phases/areas in the development process that is analyzed by the quality assurance team. Thus, the series of spreadsheets details each of the major areas that go into the predictive analysis, covering the entire development cycle. According to the illustrative embodiment, each of these spreadsheets provides an area for user input within which a member of the quality assurance team (or development team) is able to input the respective answers required to be entered into the spreadsheets. Referring specifically to FIG. 3A, the spreadsheet comprises six individual columns representing: (1) the phase of the development cycle (i.e., one of the above described 7 phases), (2) an action item among the multiple action items associated with that phase, (3) points available for each individual action item, (4) points earned, inputted by the team member (5) maximum score, which is a default maximum established, and (6) the delta between the points earned and maximum available. Notably, in the illustrative embodiment, the points within column 3 provide a measure of relative “weights,” such that the higher the number, the more “important” that particular item is to the overall development effort. Thus, for example, if a formal design inspection was accomplished, the formal design inspection would be worth a weight of “10,” while an “informal” inspection might be worth 5 or less. Conversely, if no formal design inspection was accomplished, a “−10” would be the weight assigned for that action item. Also, as may be observed, when assessing items from the latter end of the development lifecycle (such as the final item in the in the “process” section illustrated by FIG. 3F, the “subjective” assessment by the system test team carries a lot more weight (e.g., 40, if the team does not have a worry) than whether a particular tool was used (having a weight of only 5)

The first two columns within the spreadsheets are default, pre-populated columns, i.e., columns with specific action items, and other information of relevance provided therein. For example, action-column provides a detailed list of each action that is analyzed within the quantity assessments for that particular development phase. Each individual action listed in column 2 may have one or more associated selections, which are separated by the rows of the spreadsheet. Thus, within each row are a number of selections associated with each action. Each selection has assigned to it a total number of available points, indicated within “points available” column. For instance, as a part of the action described as “methodology used”, there are four possible selections, each having an associated number of available points. These selections and associated points are: (1) interaction design/outside-in design/etc.—10 points; (2) brainstorming—5 points; (3) ad-hoc—0 points; and (4) what's a design?—10 points. In this illustration, the last element, “what's a design?” is a rhetorical question indicating that no design was actually made prior to developing the software. That is, the developers simply began writing code without having a design to work from. In such situation/scenarios, the overall quality of a given product is going to be worse than if formal designs were done and inspected. Thus, having this element in the development process results in an award of a negative 10 rating). For each selection, the team member enters the number of weighted points associated with the particular action within points earned column.

When the SQDA utility is first initiated, the utility may prompt the user for information specific to the software to be analyzed. This information entered by the user may be utilize to select specific actions (from a large database of possible actions) to include within the spreadsheet analysis. The SQDA utility generates the series of spreadsheet-type GUIs, similar to the GUIs illustrated by FIGS. 3A-3F, but with software specific actions and/or selections and/or maximum points associated with each selection.

In order to analyze the quantity of the software, the developer enters the number of points associated with each row of selections within each of the respective series of spreadsheets. In one implementation, when the SDQA is initially executed and the spreadsheet view is opened, the cursor is immediately positioned within the earned points column of each GUI, and the user is able to select a particular point total for each action and enter that point total within the points earned column.

When the user completes entry of each of the required point totals for each action, SQDA utility calculates a total of the user's entries to yield the total number of quality points earned by the developer in developing the software. In one implementation, SQDA utility then completes a comparison of the points total against the scale, and SQDA utility generates an output indicating whether or not the software meets the required quality. This latter feature requires entry of a threshold value below which the required quality is not met for the software. The threshold value is pre-selected by the developer given the requirements of the customer to whom the software is being shipped. One key advantage of the business process provided by the invention over existing methods is the consistency and comprehensiveness of factors that go into the predictive analysis.

The points entered are totaled by each spreadsheet, to yield an area sub-total, and the group of area-specific sub-totals are summed together to yield an overall total for the entire design and development and test processes. As shown at the bottom of FIG. 2F, the grand total is calculated by the spreadsheet, and then that total is compared to a number scale (0-500, 500-599, 600-767) to determine whether the quality falls within the acceptable levels for the particular customer.

According to the illustrative embodiment, a maximum total of 767 is possible, when utilizing the series of spreadsheets with the illustrated action items of FIG. 2A-2F. Within the established scale for analyzing overall product quality, a good quality software product would receive a score/total of 600 or more. Software products receiving scores in this range are assumed to be ready to be shipped to the customer(s). Average quality is indicated by a score of 500 to 599, while scores below 500 indicate that the product is below quality expectations and should not be shipped/released.

In an alternative implementation, no actual predetermined “required quality” or quality level is assigned, and the resulting total/number is utilized solely to provide an assessment of the quality of the product. Then, the business needs, customer needs, etc., for the software are evaluated to determine whether the risks associated in shipping a product with, perhaps, marginal quality as indicated by the assessment, are worth it or not.

In one implementation also, individual development teams are able to tweak the spreadsheets based on the team's own set of criteria—such that the scale shown and/or utilized in the illustrative embodiments is not a “hard and fast, one size fits all” component. For example, if an initial development team is developing a component, which will only be used by other, internal product development teams and, therefore, will NOT go through a system test phase, the “spreadsheet” of that initial development team will be a subset of what was submitted and will be different than that of a team that is developing an end product that will be shipped directly to external customers.

FIG. 3 is a flow chart illustrating the process by which a developer determines, utilizing SDQA utility, whether software being developed is of the quality required for shipping to the customer. Both developer processing and SDQA utility processing are involved in the overall process. The dashed vertical line separates the two types of processing illustrated within the chart. The process begins at block 302, which illustrates the developer undertaking the software design and development process. In one implementation, the developer undertakes this development process utilizing specific criteria provided by the customer for who the software is being developed. Concurrently (or subsequently), the quality assurance team activates the SDQA utility and begins to track the development phases, as shown at block 304. At block 306, specific points are assigned to each of the selections within each major activity, according to the subjective analysis of the quality assurance team.

When the development process is completed at block 308, all of the required information is provided to SDQA utility at block 310. The SDQA utility then calculates the point total for the specific development process, indicated at block 312, and analyzes the total against the preset quality threshold(s) at block 314. SDQA utility determines at block 316 whether the required quality threshold level is met. When the level has been met, SDQA utility provides the developer a quantitative feedback result indicating that the software product meets the required levels of quality, as shown at block 318, and, in response, the developer prepares to ship the software to the customer, as indicated at block 320. Otherwise the software is referred back to the development team for further work, as shown at block 322. In one embodiment, the additional work required and/or performed is directed by the individual scores for each spreadsheet. Areas that score the worst are revisited by the software developers.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A method comprising:
tracking a process for a software development, said process comprising at least one phase and action items associated with the at least one phase that are individually quantifiable;
assigning a point total, up to a pre-established maximum total, for each of the action items based on a subjective analysis of the quality value associated with each action during the development process;
determining a final quality level of the software developed via the development process by adding together each point total for each of the action items, wherein the subjective analysis is utilized to provide a more accurate quality result than a standard objective analysis.

2. The method of claim 1, further comprising:
evaluating whether the final quality level falls within a pre-established range of quality levels, which range determines one or more of (a) a software's readiness for shipping to a customer; (b) a software meeting minimum standards for a particular use; and (c) a software requiring additional development to reach a desired quality level; and
re-working or discarding a software that fails to meet the desired quality level.

3. The method of claim 1, further comprising:
entering the point total for each action item into a software development quality analysis (SDQA) tool, wherein the tool includes a spreadsheet of each action item within each of the at least one phase;
initiating the determining step within the SDQA tool when all of the point totals have been entered.

4. The method of claim 3, wherein the SDQA tool is an application executing on a data processing system having a display device on which the spreadsheet is displayed within a graphical user interface (GUI), and wherein said entering step includes inputting each point total into the GUI using an input device of the data processing system.

5. A computer program product comprising:
a computer readable medium; and
program code on said computer readable medium for:
tracking a process for a software development, said process comprising at least one phase and action items associated with the at least one phase that are individually quantifiable;
assigning a point total, up to a pre-established maximum total, for each of the action items based on a subjective analysis of the quality value associated with each action during the development process;
determining a final quality level of the software developed via the development process by adding together each point total for each of the action items, wherein the subjective analysis is utilized to provide a more accurate quality result than a standard objective analysis.

6. The computer program product of claim 5, further comprising code for:
evaluating whether the final quality level falls within a pre-established range of quality levels, which range determines one or more of (a) a software's readiness for shipping to a customer; (b) a software meeting minimum standards for a particular use; and (c) a software requiring additional development to reach a desired quality level; and
signaling a re-work required for a software that fails to meet the desired quality level.

7. The computer program product of claim 5, further comprising code for:
displaying a graphical user interface (GUI) of a software development quality analysis (SDQA) tool within which a user enters the point total for each action item, wherein the GUI includes a spreadsheet of each action item within each of the at least one phase;
initiating the determining step within the SDQA tool when all of the point totals have been entered; and
outputting a result of the determining step to an output device.

8. The computer program product of claim 7, wherein said program code for outputting the result includes code for:
indicating an overall quality level of the software;
indicating which of the at least one phase failed to meet a pre-established minimum quality level for that phase; and
providing recommendations for improving a quality level of (a) the at least one phase that failed to meet a pre-established minimum quality level and (b) the software.

9. A software development system comprising:
a software development quality analysis (SDQA) tool that displays a spreadsheet of phases with action items related to a software development process and which receives subjective inputs about each of a series of development activity occurring during development of a software; and
a quality assurance team, having at least one person who rates the development activity during development of the software and provides the subjective inputs to the SDQA tool indicating a rating assigned to each development activity;
wherein the SDQA tool includes means for analyzing the inputs received to determining a quality level of the software developed.

10. The system of claim 9, wherein the SDQA tool is computer-implemented and further comprises:
means, when the SDQA tool receives the subjective inputs from the at least one person, for summing together the point totals allocated to the various development activity to yield a total point total; and
means for comparing the total value with a pre-established scale indicating which values correspond to a good quality, an acceptable quality, and a poor quality software product.

11. The system of claim 9, wherein the SDQA utility further comprises means for outputting a result indicating one or more of (a) whether the software is of good quality; (b) whether the quality level of the software is within a range required for shipping the software to a customer; and (c) what quality level is assigned to the overall group of development activities.

12. The system of claim 9, wherein the SDQA tool is a paper spreadsheet with locations for manually writing in each point total and tabulating a final point total for each of the phase of the development process.
